(19) United States
(12) Patent Application Publication
(10) Pub. No.: US 2026/0278933 A1
(43) Pub. Date: Sep. 17, 2026

(54) GENERATING THREE-DIMENSIONAL GAUSSIAN RECONSTRUCTIONS UTILIZING A LONG-SEQUENCE LARGE RECONSTRUCTION MODEL

(71) Applicant: Adobe Inc., San Jose, CA (US)

(72) Inventors: Ziwen Chen, Corvallis, OR (US); Zexiang Xu, San Diego, CA (US); Yicong Hong, Sunnyvale, CA (US); Sai Bi, San Jose, CA (US); Kai Zhang, San Jose, CA (US); Hao Tan, San Jose, CA (US); Fujun Luan, Santa Clara, CA (US)

(21) Appl. No.: 19/079,084

(22) Filed: Mar. 13, 2025

(51) Int. Cl. G06T 17/10; G06T 7/55; G06T 7/80; G06T 15/20

(52) U.S. Cl. CPC G06T 17/10; G06T 7/55; G06T 7/80; G06T 15/205; G06T 2207/20021; G06T 2207/20081; G06T 2207/20084; G06T 2210/52; G06T 2210/62

(57) ABSTRACT

The present disclosure relates to systems, non-transitory computer-readable media, and methods for generating three-dimensional Gaussian reconstructions of a three-dimensional scene. In one or more embodiments, the disclosed systems determine an initial set of token sequences representing a set of digital images depicting a set of views of a three-dimensional scene according to corresponding camera pose parameters. The disclosed systems utilize a set of parallel state space blocks in a hybrid feed-forward neural network to generate a set of modified token sequences from the initial set of token sequences by mixing token information. The disclosed systems utilize a transformer block in the hybrid feed-forward neural network to generate a set of output token sequences from the set of modified token sequences. The disclosed systems generate a three-dimensional Gaussian reconstruction of the three-dimensional scene for synthesizing digital images depicting the three-dimensional scene with novel views from the set of output token sequences.

### BACKGROUND

Improvements to digital image processing utilizing neural networks have increased the utility of computing systems in many digital content generation and editing processes such as reconstructing images of scenes in three-dimensional environments. A key challenge in generating three-dimensional reconstructions of a scene involves processing a plurality of input images to generate a three-dimensional reconstruction quickly and/or with limited computing resources. Specifically, three-dimensional reconstructions from multiple images typically require analyzing a plurality of images of the scene from various views to provide an understanding of the scene that allows for rendering of the scene from novel views, such that inefficiencies and inaccuracies in the processes have compounding effects on the final results. Although some existing systems exist for generating three-dimensional reconstructions of a novel view of a scene, these existing systems exhibit a number of drawbacks or disadvantages in generating three-dimensional reconstructions from a plurality of images.

### SUMMARY

This disclosure describes one or more embodiments of systems, methods, and non-transitory computer readable media that solve one or more of the foregoing or other problems in the art by leveraging a hybrid feed-forward neural network to process input images of a three-dimensional scene and generate a three-dimensional Gaussian reconstruction of the three-dimensional scene. Specifically, the disclosed systems employ a hybrid feed-forward neural network that includes a set of parallel state space blocks coupled with a transformer block (and in some cases token merging). In one or more embodiments, the disclosed systems determine an initial set of token sequences to represent a set of digital images depicting the three-dimensional scene along with corresponding camera pose parameters. Further, in one or more embodiments, the disclosed systems utilize the parallel state space blocks in combination with the transformer block of the hybrid feed-forward neural network to generate a set of output token sequences based on the initial set of token sequences. The disclosed systems generate a three-dimensional Gaussian reconstruction of the three-dimensional scene for synthesizing images with novel views of the three-dimensional scene from the set of output token sequences. In some cases, the disclosed systems use Gaussian pruning to generate the three-dimensional Gaussian from a reduced set of Gaussians.

### BRIEF DESCRIPTION OF THE DRAWINGS

The disclosure describes one or more embodiments of the invention with additional specificity and detail by referencing the accompanying figures. The following paragraphs briefly describe those figures.

FIG. 1 illustrates a diagram of an environment in which a digital scene reconstruction system operates in accordance with one or more embodiments.

FIG. 2 illustrates a diagram of an overview of the digital scene reconstruction system utilizing a hybrid feed-forward neural network to generate a three-dimensional Gaussian reconstruction in accordance with one or more embodiments.

FIG. 3 illustrates a diagram of the digital scene reconstruction system generating a three-dimensional Gaussian reconstruction from a set of digital images in accordance with one or more embodiments.

FIG. 4 illustrates a diagram of the digital scene reconstruction system generating an initial set of token sequences from a plurality of digital images in accordance with one or more embodiments.

FIG. 5 illustrates a diagram of the digital scene reconstruction system utilizing the hybrid feed-forward neural network to generate a set of output token sequences in accordance with one or more embodiments.

FIG. 6 illustrates a diagram of the digital scene reconstruction system merging an initial set of token sequences in accordance with one or more embodiments.

FIG. 7 illustrates a diagram of the digital scene reconstruction system applying an opacity filter to generate a filtered set of Gaussians in accordance with one or more embodiments.

FIG. 8 illustrates a diagram of the digital scene reconstruction system training the hybrid feed-forward neural network in accordance with one or more embodiments.

FIG. 9 illustrates an example schematic diagram of the digital scene reconstruction system in accordance with one or more embodiments.

FIG. 10 illustrates an example flowchart of a series of acts for generating a three-dimensional Gaussian reconstruction utilizing a hybrid feed-forward neural network based on digital images in accordance with one or more embodiments.

FIG. 11 illustrates a block diagram of an example computing device in accordance with one or more embodiments.

### DETAILED DESCRIPTION

This disclosure describes one or more embodiments of a digital scene reconstruction system that leverages a hybrid feed-forward neural network to generate a three-dimensional Gaussian reconstruction for novel view generation of a three-dimensional scene from a set of digital images of a scene. For example, the digital scene reconstruction system extracts token sequences from a set of digital images depicting a set of views of a three-dimensional scene (e.g., a room, an object) according to camera pose parameters. The digital scene reconstruction system utilizes a set of parallel state space blocks and a transformer block in the hybrid feed-forward neural network to process the extracted token sequences and generate a set of output token sequences. In certain embodiments, the digital scene reconstruction system mixes token information (e.g., by merging tokens) in the initial set of token sequences as part of generating the set of output token sequences. Additionally, the digital scene reconstruction system generates a three-dimensional Gaussian reconstruction of the three-dimensional scene from the set of output token sequences for use in generating synthesized digital images with one or more novel views of the scene.

As mentioned, in one or more embodiments, the digital scene reconstruction system extracts an initial set of token sequences from a set of digital images and camera pose parameters corresponding to the set of digital images. Specifically, the digital scene reconstruction system processes the set of digital images representing a set of views or perspectives of a three-dimensional scene (e.g., multiple perspectives of a room) to extract image feature embeddings from the set of digital images. In one or more embodiments, the digital scene reconstruction system also extracts camera feature embeddings from the camera pose parameters (e.g., μlücker rays) of the set of digital images. In one or more embodiments, the digital scene reconstruction system combines the image feature embeddings and the camera feature embeddings into the initial set of token sequences.

In one or more embodiments, the digital scene reconstruction system utilizes a set of parallel state space blocks of the hybrid feed-forward neural network to generate a set of modified token sequences from the initial set of token sequences. Furthermore, the digital scene reconstruction system utilizes a transformer block of the hybrid feed-forward neural network to generate a set of output token sequences from the set of modified token sequences. In certain embodiments, the digital scene reconstruction system iteratively processes the initial set of token sequences through the set of parallel state space blocks and the transformer block in sequence to generate the set of output token sequences.

In one or more additional embodiments, the digital scene reconstruction system also utilizes a token merger to merge tokens to generate the set of output sequences from the initial set of token sequences. For example, the digital scene reconstruction system utilizes the token merger to merge the initial set of token sequences and generate a downsampled set of token sequences. Additionally, the digital scene reconstruction system utilizes the downsampled set of token sequences to generate a merged set of token sequences for reducing the overall length of the token sequences processed by the hybrid feed-forward neural network.

In one or more embodiments, the digital scene reconstruction system utilizes Gaussian pruning to filter Gaussians for generating a three-dimensional Gaussian reconstruction of the three-dimensional scene from the output set of token sequences. Specifically, in one or more embodiments, the digital scene reconstruction system utilizes an opacity threshold to filter a subset of Gaussians from the set of Gaussians generated by the output set of token sequences that do not meet the opacity threshold. Further, in one or more embodiments, the digital scene reconstruction system trains the hybrid feed-forward neural to reduce the opacity of the Gaussians and optimize the positions of generated Gaussians.

As suggested above, existing systems exhibit drawbacks or deficiencies in accurately and consistently generating novel views from multiple digital images of a three-dimensional scene. Although some conventional systems generate three-dimensional Gaussian reconstructions for generating novel views of a three-dimensional scene from more than one digital image, such systems have a number of problems in relation to accuracy, flexibility, and efficiency. For instance, conventional systems inaccurately generate three-dimensional Gaussian reconstructions because the systems are limited to small numbers of input digital images (often four or less) due to the amount of resources required to process the images via the models used by the conventional systems. Accordingly, the conventional systems are limited in their ability to generate a variety of different perspectives of the three-dimensional scene with sufficient accuracy.

Additionally, conventional systems are inflexible in generating novel views of scenes represented in digital images. For instance, as mentioned above, conventional systems are limited to small numbers of input digital images due to the resource constraints imposed by the specific architectures of the conventional systems. Further, conventional systems are limited to utilizing lower-resolution digital images (e.g., a maximum resolution of 256×256). As a result, conventional systems are limited in both the number and the quality of digital images usable as input, which also impacts the accuracy of scene reconstruction processes and novel view generation processes.

Further, conventional systems are inefficient. For instance, certain conventional systems require substantial amounts of time and processing power to reconstruct a three-dimensional scene based on input images. In particular, some conventional systems require hours or even days to generate three-dimensional Gaussian reconstructions of the three-dimensional scenes from input images, with more efficient conventional systems still requiring dozens of minutes, which limits their usability to certain situations and to certain types of devices. Further, certain conventional systems require large amounts of processing due to the use of complex artificial neural networks, involving thousands of graphics processing units (GPU's) operating in parallel, to generate the three-dimensional Gaussian reconstructions.

As suggested, embodiments of the digital scene reconstruction system provide several advantages and benefits over conventional systems. For example, the digital scene reconstruction system improves accuracy over conventional systems. In contrast to conventional systems that are limited to utilizing a small number of input digital images, the digital scene reconstruction system is capable of long sequences of input digital images at the same time, improving its ability to accurately reconstruct the three-dimensional scene from a novel view. More specifically, the digital scene reconstruction system is able to generate a three-dimensional Gaussian reconstruction of the three-dimensional scene from a novel view that has improved accuracy in depicting the features of the three-dimensional scene by leveraging a hybrid feed-forward network capable of processing long sequences of digital images.

Further, the digital scene reconstruction system improves flexibility over previous systems. In contrast to conventional systems that are limited to a small number of input digital images, the digital scene reconstruction system is capable of utilizing up to thirty-two input digital images at the same time, improving its ability to flexibly generate the three-dimensional reconstruction without restricting user input. Further, unlike prior systems, the digital scene reconstruction system is capable of flexibly incorporating digital images with a higher resolution. This allows the digital scene reconstruction system to flexibly incorporate both a larger number of digital images and digital images at a higher resolution quality.

The digital scene reconstruction system also improves efficiency relative to conventional systems. Specifically, by utilizing the hybrid feed-forward neural network with token merging and Gaussian filtering, the digital scene reconstruction system generates three-dimensional Gaussian reconstructions both more quickly than conventional systems and without requiring the computing power of conventional systems. For example, the digital scene reconstruction system is capable of generating three-dimensional Gaussian reconstructions from long sequences of digital images in seconds, as opposed to dozens of minutes from short sequences of digital images for certain conventional systems. Additionally, the digital scene reconstruction system, based on its hybrid feed-forward neural network architecture as well as utilizing token merging and Gaussian filtering, is capable of generating three-dimensional Gaussian reconstructions with lower, consistent processing requirements for various lengths of sequences of digital images.

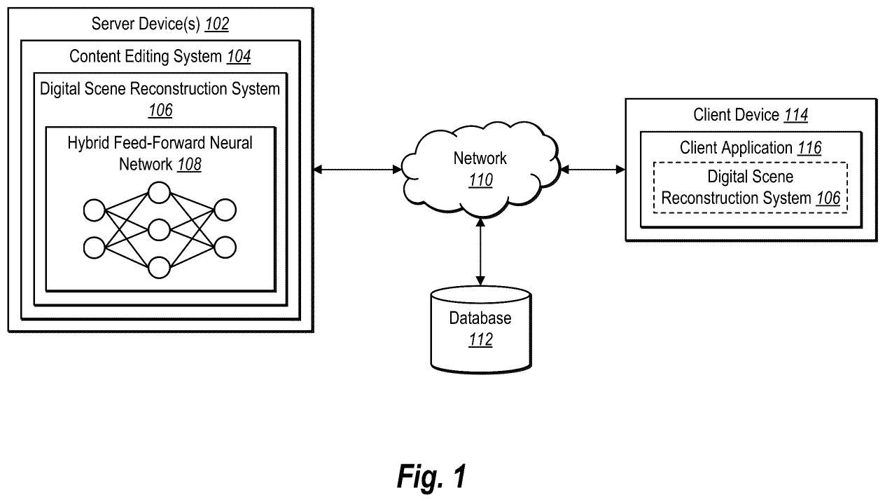

Additional detail regarding the digital scene reconstruction system 106 will now be provided with reference to the figures. For example, FIG. 1 illustrates a schematic diagram of an example system environment for implementing a digital scene reconstruction system 106 in accordance with one or more embodiments. An overview of the digital scene reconstruction system 106 is described in relation to FIG. 1. Thereafter, a more detailed description of the component and processes of the digital scene reconstruction system 106 is provided in relation to the subsequent figures.

As show, the environment includes server device(s) 102, a database 112, a network 110, and a client device 114. Each of the components of the environment communicate via the network 110, and the network 110 is any suitable network over which computing devices communicate.

As mentioned, the environment includes a client device 114. The client device 114 is one of a variety of computing devices, including a smartphone, a tablet, a smart television, a desktop computer, a laptop computer, a virtual reality device, an augmented reality device, or another computing device. The client device 114 communicates with the server device(s) 102 via the network 110. For example, the client device 114 provides information to server device(s) 102 indicating client device interactions (e.g., providing input digital images of a three-dimensional scene) and receives information from the server device(s) 102 (e.g., a three-dimensional Gaussian reconstruction and/or a novel view of the three-dimensional scene). Thus, in some cases, the digital scene reconstruction system 106 on the server device(s) 102 provides and receives information based on client device interaction via the client device 114.

As shown in FIG. 1, the client device 114 includes a client application 116. In particular, the client application 116 is a web application, a native application installed on the client device 114 (e.g., a mobile application, a desktop application, etc.), or a cloud-based application where all or part of the functionality is performed by the server device(s) 102. Based on instructions from the client application 116, the client device 114 presents or displays information to a user. In some cases, the client device 114 includes a version of the digital scene reconstruction system 106.

As illustrated in FIG. 1, the environment includes the server device(s) 102. The server device(s) 102 generates, tracks, stores, processes, receives, and transmits electronic data, such as digital images, three-dimensional Gaussian reconstructions, and training information. The server device(s) 102, for example, receives data from the client device 114 in the form of an indication of a client device interaction (e.g., input digital images) to generate a three-dimensional Gaussian reconstruction of a scene for generating a novel perspective of the scene from the client device interaction. In response, the server device(s) 102 transmits data to the client device 114 to display or present a reconstruction of a scene from a novel perspective based on the client device interaction.

In some embodiments, the server device(s) 102 communicates with the client device 114 to transmit and/or receive data via the network 110, including client device interactions, digital designs, and/or other data. In some embodiments, the server device(s) 102 comprises a distributed server where the server device(s) 102 includes a number of server devices distributed across the network 110 and located in different physical locations. The server device(s) 102 comprise a content server, an application server, a communication server, a content editing server, a web-hosting server, a multidimensional server, and/or a machine learning server. The server device(s) 102 further access and utilize the database 112 to store and retrieve information such as digital images, and all or part of the hybrid feed-forward neural network 108.

In some cases, a hybrid feed-forward neural network includes or refers to a type of neural network that combines multiple architectures, techniques, or data modalities within a feed-forward structure. For example, a hybrid feed-forward neural network integrates elements such as convolutional layers, recurrent connections, or attention mechanisms. In one or more embodiments, a hybrid model uses state space blocks coupled with a transformer block, leveraging the strengths of both architectures in a single framework.

Relatedly, in some embodiments, a state space block is a network architecture used in machine learning that models sequential data through state-space representations. For example, a state space block leverages structured linear dynamics and gating mechanisms to efficiently capture long-range dependencies. In particular, state space blocks use discretized state-space models to model attention and process data.

Additionally, in some embodiments, a transformer block is a network architecture designed to process sequential data by focusing on the relationships between elements, regardless of the positions of the elements in the sequence. In particular, a transformer block assigns varying levels of importance to different parts of input data to enable context-aware processing. For example, a transformer block includes multiple layers, with each layer including self-attention modules and feed-forward network, with the transformer block using positional encodings to retain order information for tasks like language modeling and machine translation.

Relatedly, in some embodiments, a neural network includes or refers to a machine learning model trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., three-dimensional Gaussian reconstructions of a scene from a novel view) based on a plurality of inputs provided to the neural network. In some cases, a neural network refers to an algorithm (or a set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, or a large language model.

As further shown in FIG. 1, the server device(s) 102 also includes the digital scene reconstruction system 106 as part of a content editing system 104. For example, in one or more implementations, the content editing system 104 is able to store, generate, modify, edit, enhance, provide, distribute, and/or share digital content. For example, the content editing system 104 provides tools for the client device 114, via the client application 116, to generate reconstructions of a scene from a novel view using the hybrid feed-forward neural network 108.

In one or more embodiments, the server device(s) 102 includes all, or a portion of, the digital scene reconstruction system 106. For example, the digital scene reconstruction system 106 operates on the server device(s) 102 to generate three-dimensional Gaussian reconstructions of a scene from a novel view. In some cases, the digital scene reconstruction system 106 utilizes, locally on the server device(s) 102 or from another network location (e.g., the database 112), the hybrid feed-forward neural network 108 to generate a three-dimensional Gaussian reconstruction of a scene for generating a novel view of the scene.

In certain cases, the client device 114 includes all or part of the digital scene reconstruction system 106. For example, the client device 114 generates, obtains (e.g., downloads), or utilizes one or more aspects of the digital scene reconstruction system 106 from the server device(s) 102. Indeed, in some implementations, as illustrated in FIG. 1, the digital scene reconstruction system 106 is located in whole or in part on the client device 114. For example, the digital scene reconstruction system 106 includes a web hosting application that allows the client device 114 to interact with the server device(s) 102. To illustrate, in one or more implementations, the client device 114 accesses a web page supported and/or hosted by the server device(s) 102.

In one or more embodiments, the client device 114 and the server device(s) 102 work together to implement the digital scene reconstruction system 106. For example, in some embodiments, the server device(s) 102 train the hybrid feed-forward neural network 108 and provide the hybrid feed-forward neural network 108 to the client device 114 for implementation. In some embodiments, the client device 114 attaches a set of digital images of a three-dimensional scene, the server device(s) 102 generates a novel view of the three-dimensional scene based on a three-dimensional Gaussian reconstruction of the three-dimensional scene, and the client device 114 presents the novel view. Furthermore, in some implementations, the client device 114 assists in generating the three-dimensional Gaussian reconstruction and/or the novel view.

Although FIG. 1 illustrates a particular arrangement of the environment, in some embodiments, the environment has a different arrangement of components and/or may have a different number or set of components altogether. For instance, as mentioned, the digital scene reconstruction system 106 is implemented by (e.g., located entirely or in part on) the client device 114. In addition, in one or more embodiments, the client device 114 communicates directly with the digital scene reconstruction system 106, bypassing the network 110. Further, in some embodiments, the hybrid feed-forward neural network 108 includes one or more components stored in the database 112, maintained by the server device(s) 102, the client device 114, or a third-party device.

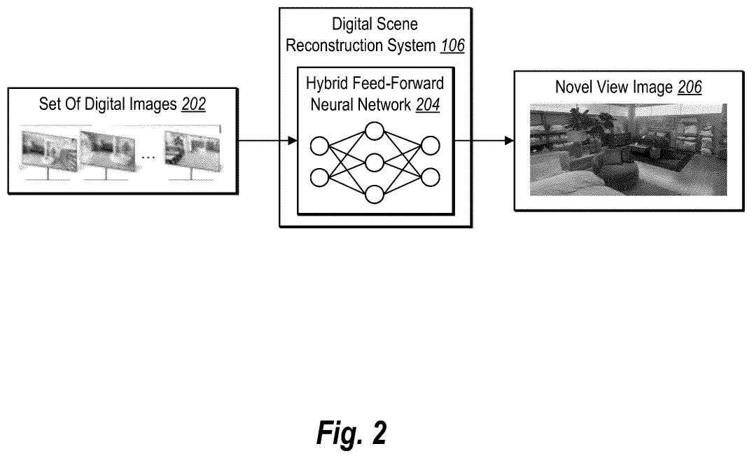

As mentioned, in one or more embodiments, the digital scene reconstruction system 106 generates a novel view of a three-dimensional scene according to a three-dimensional Gaussian reconstruction. FIG. 2 illustrates an overview of the digital scene reconstruction system 106 generating a novel view of a scene from a set of digital images by utilizing a hybrid feed-forward neural network to generate a three-dimensional Gaussian reconstruction in accordance with one or more embodiments. Additional detail regarding the various acts and processes mentioned with respect to FIG. 2 is provided thereafter with respect to subsequent figures.

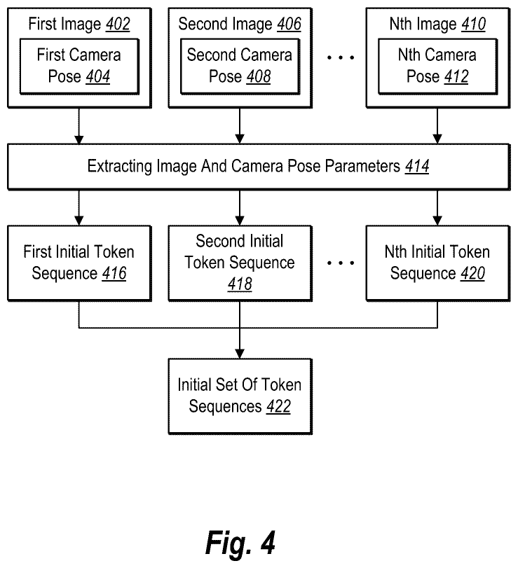

As illustrated in FIG. 2, the digital scene reconstruction system 106 processes a set of digital images 202 depicting a three-dimensional scene. For example, the set of digital images 202 include photographs or rendered images of a scene with three-dimensional relationships among objects. In particular, the digital scene reconstruction system 106 processes the set of digital images 202 (e.g., utilizing an encoder neural network) to determine a set of parameters or features for each digital image, including image feature embeddings depicting color values and camera pose parameters according to the perspectives of the digital images. In one or more embodiments, the digital scene reconstruction system 106 utilizes the set of digital images 202 to analyze a three-dimensional scene from a plurality of perspectives. FIG. 4 and the corresponding description provide additional detail related to processing the set of digital images 202 to determine the set of parameters for each digital image.

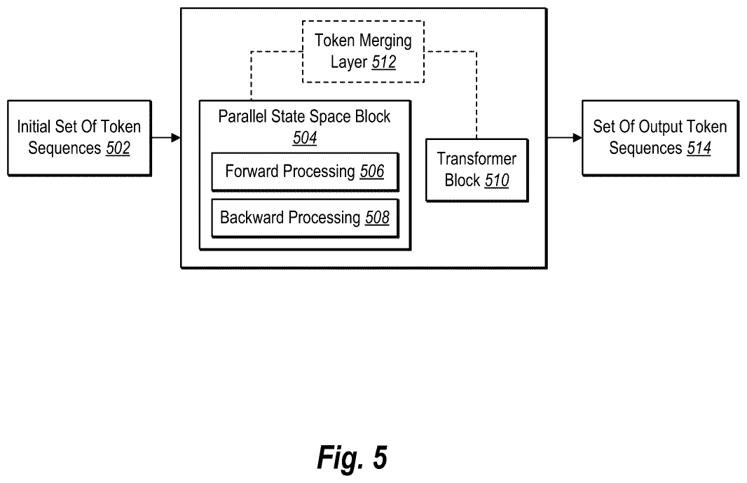

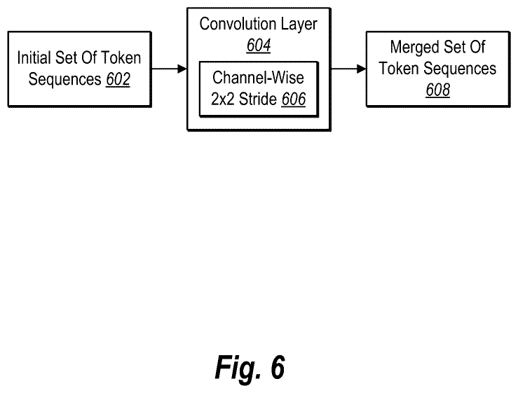

As further illustrated in FIG. 2, the digital scene reconstruction system 106 processes the set of digital images 202 through a hybrid feed-forward neural network 204 as part of the digital scene reconstruction system 106. In particular, the digital scene reconstruction system 106 utilizes the hybrid feed-forward neural network 204 to generate a set of output token sequences representing the three-dimensional scene from a novel perspective. In one or more embodiments, the digital scene reconstruction system 106 utilizes the hybrid feed-forward neural network 204 to generate a set of output token sequences encoding a set of Gaussians representing the three-dimensional scene. FIGS. 5-6 and the corresponding description provide additional detail related to processing the set of digital images 202 through the hybrid feed-forward neural network 204.

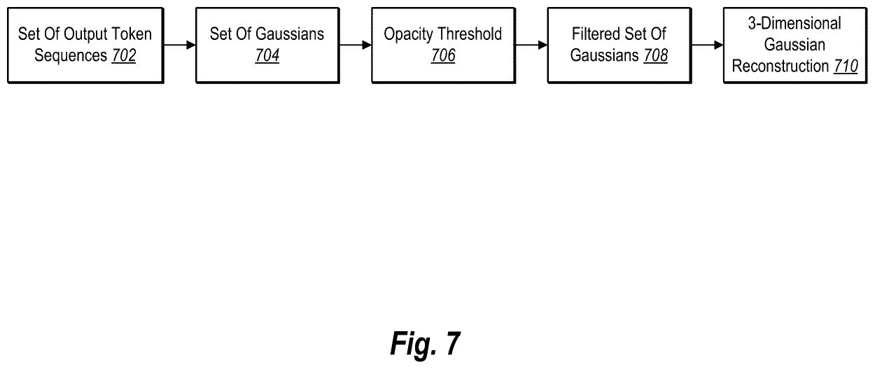

As further illustrated in FIG. 2, the digital scene reconstruction system 106 generates a novel view image 206 depicting the three-dimensional scene shown in the set of digital images 202 from a novel perspective. In particular, the digital scene reconstruction system 106 generates the novel view image 206 based on a generated set of Gaussians depicting the image features (e.g., color) from a novel camera pose. In one or more embodiments, the digital scene reconstruction system 106 generates the novel view image 206 after pruning a set of Gaussians from the generated set of Gaussians that fall below an opacity filter. FIG. 7 and the corresponding description provide additional detail related to generating the three-dimensional Gaussian reconstruction used as a basis for generating the novel view image 206.

In some cases, a Gaussian is a three-dimensional distribution at a three-dimensional point in space with shape, scale, rotation, opacity, and color. In particular, the digital scene reconstruction system 106 uses collections of Gaussians as primitives to represent complex scenes, where each Gaussian contributes to the final rendered image through accumulation and blending. For example, Gaussian splatting is a technique that utilizes Gaussians to reconstruct three-dimensional scenes by optimizing the Gaussians' properties, allowing for efficient and continuous view synthesis.

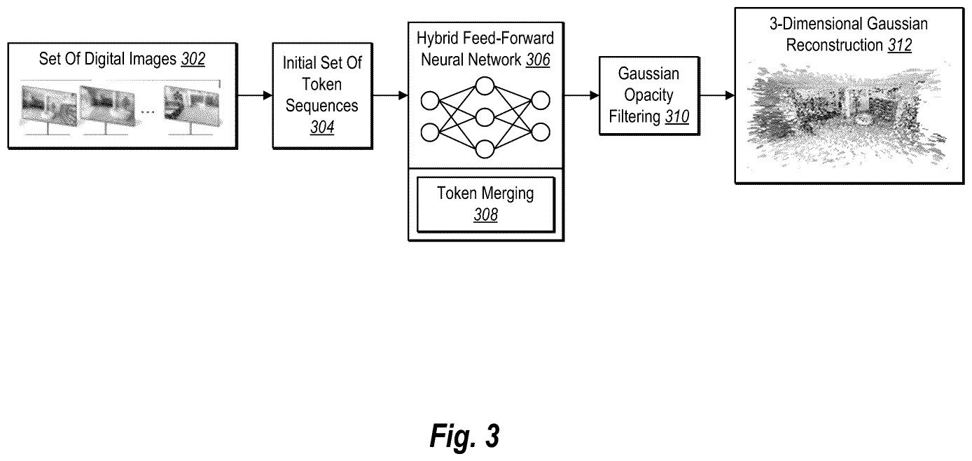

As mentioned, in one or more embodiments, the digital scene reconstruction system 106 generates a three-dimensional Gaussian reconstruction utilizing a hybrid feed-forward neural network. FIG. 3 illustrates an overview of the digital scene reconstruction system 106 processing a set of digital images through a hybrid feed-forward neural network to generate a three-dimensional Gaussian reconstruction of a scene. Additional detail regarding the various acts and processes mentioned with respect to FIG. 3 is provided thereafter with respect to subsequent figures.

As illustrated in FIG. 3, the digital scene reconstruction system 106 processes a set of digital images 302 to generate an initial set of token sequences 304. In one or more embodiments, the digital scene reconstruction system 106 generates the initial set of token sequences 304 to represent attributes of the set of digital images 302. In particular, the digital scene reconstruction system 106 determines the initial set of token sequences 304 by extracting both image feature embeddings, which depict color values of the set of digital images 302, and camera feature embeddings, which depict camera pose parameters of the set of digital images 302. In one or more embodiments, the digital scene reconstruction system 106 combines the extracted embeddings of the set of digital images 302 and the corresponding camera pose parameters to generate the initial set of token sequences 304. FIG. 4 and the corresponding description provide additional detail related to generating the initial set of token sequences.

As further illustrated in FIG. 3, the digital scene reconstruction system 106 processes the initial set of token sequences 304 through a hybrid feed-forward neural network 306. In one or more embodiments, the digital scene reconstruction system 106 utilizes the hybrid feed-forward neural network 306 to generate a set of output token sequences representing a three-dimensional Gaussian reconstruction of the three-dimensional scene depicted by the set of digital images 302 for use in generating a new digital image from a novel perspective. FIG. 5 and the corresponding description provide additional detail related to generating the set of output token sequences.

As further illustrated in FIG. 3, in certain embodiments, the digital scene reconstruction system 106 utilizes token merging 308 within the hybrid feed-forward neural network 306. In particular, the digital scene reconstruction system 106 utilizes the token merging 308 to reduce the size/dimensionality of the initial set of token sequences 304 to reduce computational cost and improve computational speed. In one or more embodiments, the digital scene reconstruction system 106 utilizes a convolutional layer within the hybrid feed-forward neural network 306 to perform the token merging 308. FIG. 6 and the corresponding description provide additional detail related to performing the token merging 308. Furthermore, in one or more embodiments, the digital scene reconstruction system 106 utilizes the hybrid feed-forward neural network 306 to generate a set of output tokens representing Gaussians after the token merging 308.

As further illustrated in FIG. 3, the digital scene reconstruction system 106 performs a Gaussian opacity filtering 310 as part of generating a three-dimensional Gaussian reconstruction 312 (e.g., from the set of output tokens). In particular, the digital scene reconstruction system 106 utilizes the Gaussian opacity filtering 310 to filter out Gaussians having opacity values that fall below a certain threshold. In one or more embodiments, the digital scene reconstruction system 106 performs the Gaussian opacity filtering 310 to remove Gaussians likely forming an overlap, reducing computational cost and improving computational speed. Further, the digital scene reconstruction system 106 generates the three-dimensional Gaussian reconstruction 312 from the remaining Gaussians following the Gaussian opacity filtering 310. FIG. 7 and the corresponding description provide additional detail related to performing the Gaussian opacity filtering 310.

As mentioned, in one or more embodiments, the digital scene reconstruction system 106 generates an initial set of token sequences. FIG. 4 illustrates a diagram of the digital scene reconstruction system 106 generating an initial set of token sequences representing image and camera pose parameters for a set of digital images in accordance with one or more embodiments. In particular, FIG. 4 illustrates that the digital scene reconstruction system 106 extracts features from a plurality of digital images (e.g., a long sequence of digital images) and their corresponding camera pose parameters. In various embodiments, the digital scene reconstruction system 106 generates novel view images from sequences of many digital images (e.g., upwards of 32 or more images).

As illustrated in FIG. 4, the digital scene reconstruction system 106 processes a first image 402 depicting a three-dimensional scene (e.g., a room or other three-dimensional environment including three-dimensional objects) with a first camera pose 404. In particular, the digital scene reconstruction system 106 processes the first image 402 to determine image features, such as color values (e.g., RGB values). Further, in one or more embodiments, the digital scene reconstruction system 106 processes the first image 402 or metadata associated with the first image 402 to determine a first camera pose 404. In one or more embodiments, the digital scene reconstruction system 106 determines the first camera pose 404 according to a plurality of parameters, including camera pose depth, camera pose position, and camera pose direction. In certain embodiments, the digital scene reconstruction system 106 represents the first camera pose 404 as Plücker rays.

In some cases, a Plücker ray refers to a mathematical representation of a directed line in three-dimensional space. In particular, a Plücker ray utilizes six homogenous coordinates to represent the direction and moment of a line, allowing for efficient geometric computations such as intersection tests and spatial relationships. In additional embodiments, the digital scene reconstruction system 106 determines the first camera pose 404 including camera coordinates, a direction, and lens parameters.

As further illustrated in FIG. 4, the digital scene reconstruction system 106 processes a second image 406 through an Nth image 410, with a corresponding second camera pose 408 through an Nth camera pose 412. In particular, the second image 406 and the Nth image 410 depict the same three-dimensional scene as the first image 402, but from different camera poses or perspectives of the three-dimensional scene. In particular, the digital scene reconstruction system 106 processes the second image 406 through the Nth image 410 to determine image feature parameters and camera pose parameters (e.g., the second camera pose 408 and the Nth camera pose 412) of the second image 406 and the Nth image 410.

As further illustrated in FIG. 4, the digital scene reconstruction system 106 performs an act of extracting image and camera pose parameters 414 on the first image 402, the second image 406, and the Nth image 410. In particular, the digital scene reconstruction system 106 extracts the image and camera pose parameters by utilizing one or more encoder neural networks to extract image feature embeddings from the digital images and camera feature embeddings from the camera pose parameters. In one or more embodiments, the digital scene reconstruction system 106 utilizes the one or more encoder neural networks to patchify for generating the image feature embeddings and the camera feature embeddings. In certain embodiments, the digital scene reconstruction system 106 utilizes the one or more encoder neural networks to linearly transform extracted features (e.g., the patchified features) of the images and camera pose parameters to generate the image feature embeddings and the camera feature embeddings.

In one or more embodiments, the digital scene reconstruction system 106 patchifies the images by dividing the images into smaller, fixed-size segments (e.g., 8×8 patches). For instance, the digital scene reconstruction system 106 patchifies to the images by splitting the images into non-overlapping patches that serve as input tokens to the linear layer. Additionally, in some embodiments, the digital scene reconstruction system 106 patchifies an image by flattening the image and embedding the image into a high-dimensional space to generate a smaller segment.

In one or more embodiments, the digital scene reconstruction system 106 linearly transforms an image by utilizing a neural network (e.g., one or more neural network layers) to map image data into a new representation while preserving the linear structure of the image data. For instance, linearly transforming an image involves the digital scene reconstruction system 106 projecting image patches into a high-dimensional state before feeding them into another model. In one or more embodiments, digital scene reconstruction system 106 generates a linear transformation of an image to create token embeddings (e.g., based on patches of the image).

As further illustrated in FIG. 4, the digital scene reconstruction system 106 generates a plurality of token sequences based on the extracted embeddings of the images and their corresponding camera pose parameters. For example, the digital scene reconstruction system 106 generates a first initial token sequence 416, a second initial token sequence 418, and an Nth initial token sequence 420 corresponding to the first image 402, the second image 406, and the Nth image 410. For instance, the first initial token sequence 416 represents the image feature parameters of the first image 402 and the camera pose parameters of the first camera pose 404 in tokenized format. Similarly, the digital scene reconstruction system 106 generates the second initial token sequence 418 from the extracted features of the second image 406 and the second camera pose 408 and the Nth initial token sequence 420 from the features of the Nth image 410 and the Nth camera pose 412.

The digital scene reconstruction system 106 further combines all token sequences from the images and their corresponding camera pose parameters into a set of token sequences. For instance, the digital scene reconstruction system 106 combines the first initial token sequence 416, the second initial token sequence 418, and the Nth initial token sequence 420 to generate an initial set of token sequences 422. In one or more embodiments, the digital scene reconstruction system 106 generates the initial set of token sequences 422 by concatenating the first initial token sequence 416, the second initial token sequence 418, and the Nth initial token sequence 420. As mentioned, in one or more embodiments, the digital scene reconstruction system 106 transforms an initial set of token sequences into a set of output token sequences representing Gaussians for generating a Gaussian reconstruction of a scene. FIG. 5 illustrates a diagram depicting utilizing a hybrid feed-forward neural network to process an initial set of token sequences representing a sequence of images and corresponding camera pose parameters to generate a set of output token sequences representing Gaussians.

As illustrated in FIG. 5, the digital scene reconstruction system 106 processes the initial set of token sequences 502 through a hybrid feed-forward neural network including a set of state space blocks with a separate transformer block in series with the set of state space blocks. In one or more embodiments, the set of state space blocks includes a plurality of parallelized state space blocks to leverage parallel computational processing, such as in a GPU. Furthermore, in various embodiments, the set of state space blocks is followed by the transformer block (e.g., as illustrated in FIG. 5), though in other embodiments, the transformer block is before the set of state space blocks.

In one or more embodiments, as illustrated, the digital scene reconstruction system 106 utilizes a parallel state space block 504 to process the initial set of token sequences 502 by mixing the token information (e.g., image and camera pose parameters) within the initial set of token sequence 502 corresponding to the long sequence of images and generating a modified token sequence of the same shape. In one or more embodiments, as illustrated, the digital scene reconstruction system 106 utilizes the parallel state space block 504 to process the initial set of token sequences 502 bidirectionally to take into account information before and after each token while mixing information in the initial set of token sequences 502. In one or more embodiments, the digital scene reconstruction system 106 processes the initial set of token sequences 502 through a set of state space blocks operating in parallel (e.g., seven state space blocks operating in parallel).

As further illustrated in FIG. 5, the digital scene reconstruction system 106 utilizes the parallel state space block 504 to perform forward processing 506 and backward processing 508 on the initial set of token sequences 502 utilizing separate convolution processes. In particular, the digital scene reconstruction system 106 performs the forward processing 506 and the backward processing 508 over the initial set of token sequences 502 to bi-directionally scan the initial set of token sequences. In one or more embodiments, the digital scene reconstruction system 106 performs the forward processing 506 and the backward processing 508 after passing the initial set of token sequences through a first layer of the parallel state space block 504. Additionally, the digital scene reconstruction system 106 combines the output of the forward processing 506 and the backward processing 508 before passing the output to a transformer block (e.g., the transformer block 510). In one or more embodiments, the digital scene reconstruction system 106 combines the output of the forward processing 506 and the backward processing 508 by summing the output of the forward processing 506 and the backward processing 508 in a second linear layer. In additional embodiments, the digital scene reconstruction system 106 combines the outputs of all parallel state space blocks for providing to the transformer block 510.

In one or more embodiments, the digital scene reconstruction system 106 utilizes a state space block to process the initial set of token sequences 502 according to the following formula:

$${h}_{t} = {Ah}_{t - 1} + {Bx}_{t}$$

$${y}_{t} = {Ch}_{t}$$

where h is a hidden state, y is an output token, t is the sequence index, and A, B, and C are parameters (e.g., parameters included in the initial set of token sequences 502).

In one or more embodiments, a state space block includes an architecture designed for efficient sequence modeling. In particular, the set of state space blocks utilize state-space models to capture long-range dependencies while maintaining linear scaling in computation. For example, a state space block processes token sequences using selective gating and convolution-based updates, enabling efficient handling of long-context dependencies.

As further illustrated in FIG. 5, the digital scene reconstruction system 106 utilizes a transformer block 510 to process the output of the parallel state space block 504. In one or more embodiments, the digital scene reconstruction system 106 utilizes the transformer block 510 to generate a set of output token sequences 514. Additionally, the digital scene reconstruction system 106 utilizes the transformer block 510 to use as an input for an additional processing iteration by the parallel state space block 504. In one or more embodiments, the digital scene reconstruction system 106 processes the initial set of token sequences through the sequence of the parallel state space block 504 and the transformer block 510 a set number of times (e.g., two or three times) before generating the set of output token sequences 514. In certain embodiments, the digital scene reconstruction system 106 utilizes the transformer block 510 to transform the output of the parallel state space block 504 to use as an input for token merging layer 512, with the token merging layer 512 being an optional step.

In one or more embodiments, the digital scene reconstruction system 106 performs an optional token merging process to reduce the size/dimensionality of the input tokens for processing via one or more components of the hybrid feed-forward neural network. For example, as further illustrated in FIG. 5, the digital scene reconstruction system 106 utilizes a token merging layer 512 to merge token sequence information prior to processing via the set of state space blocks. In particular, the digital scene reconstruction system 106 utilizes the token merging layer 512 to reduce the length/change the shape of token sequences processed via the separate blocks of the hybrid feed-forward neural network. The digital scene reconstruction system 106 thus utilizes the token merging layer 512 to reduce the processing requirements of one or more components of the hybrid feed-forward neural network.

In one or more embodiments, the digital scene reconstruction system 106 utilizes a plurality of iterations (e.g., two, three, or more) of the hybrid feed-forward neural network to process the initial set of token sequences 502. Accordingly, in one or more embodiments, the digital scene reconstruction system 106 places the token merging layer 512 before the set of state space blocks at the beginning of an iteration (e.g., before the second iteration) of the hybrid feed-forward neural network. Thus, the digital scene reconstruction system 106 provides the output of the transformer block 510 after the first iteration to the token merging layer 512 before the parallel state space block 504 in the second iteration. FIG. 6 and the corresponding description provide additional detail related to token merging.

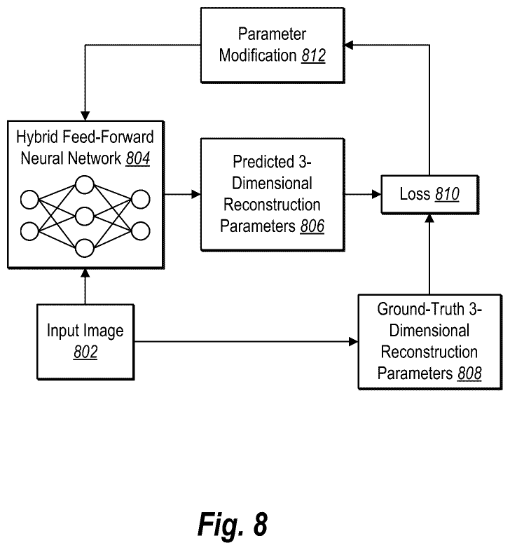

As further illustrated in FIG. 5, the digital scene reconstruction system 106 generates a set of output token sequences 514 utilizing the hybrid feed-forward neural network. In particular, the digital scene reconstruction system 106 generates the set of output token sequences 514 to represent a set of Gaussians for generating a three-dimensional Gaussian reconstruction of the scene depicted in input image (e.g., the set of digital images 302 in FIG. 3). In one or more embodiments, the digital scene reconstruction system 106 generates or modifies the set of output token sequences 514 by filtering a set of Gaussians based on opacity and/or specific training processes. FIG. 7 and the corresponding description provide additional detail related to filtering Gaussians by opacity. FIG. 8 and the corresponding description provide additional detail related to training the hybrid feed-forward neural network.

As mentioned, in one or more embodiments, the digital scene reconstruction system 106 merges token sequences via a token merging layer to reduce the size/dimensionality of tokens processed via one or more neural network layers. FIG. 6 illustrates a diagram of the digital scene reconstruction system 106 generating a merged (transformed) set of token sequences by feeding an initial set of token sequences through a token merging layer. In one or more embodiments, as illustrated, the token merging layer includes a strided convolution layer.

As illustrated in FIG. 6, the digital scene reconstruction system 106 processes an initial set of token sequences 602 by utilizing a convolution layer 604 to reshape the initial set of token sequences. For example, the digital scene reconstruction system 106 utilizes the convolution layer 604 to reshape the initial set of token sequences from a dimensionality of L×D, where L is the sequence length and D is the dimensionality of each token, to

$$N \times \frac{H}{p} \times \frac{W}{p} \times D ,$$

where N is the batch size, H is the original height of an input image, W is the original width of an input image, and p is the patch size (the factor by which the input image was divided into patches during tokenization). As further illustrated in FIG. 6, the digital scene reconstruction system 106 utilizes the convolution layer 604 with a channel-wise 2×2 stride 606 to reshape the initial set of token sequences 602. For example, the digital scene reconstruction system 106 utilizes the convolution layer 604 to apply the channel-wise 2×2 stride 606 to downsample the initial set of token sequences 602 and generate an intermediate output shape of

$$N \times \frac{H}{2 p} \times \frac{W}{2 p} \times {D}^{′} ,$$

where D′ is a new token dimension. In one or more additional embodiments, the digital scene reconstruction system 106 reshapes the intermediate output shape to generate a merged set of token sequences 608 as

$$\frac{L}{4} \times {D}^{′} ,$$

thereby reducing the length and dimensionality of the tokens. In particular, the digital scene reconstruction system 106 generates the merged set of token sequences 608 to reduce memory usage and increase training speed.

As mentioned, in one or more embodiments, the digital scene reconstruction system 106 generates a set of Gaussians representing a long sequence of images utilizing a hybrid feed-forward neural network and filters the Gaussians by opacity. FIG. 7 illustrates a diagram of the digital scene reconstruction system 106 filtering generated Gaussians by opacity before generating a three-dimensional Gaussian reconstruction of a scene based on a long sequence of digital images.

As illustrated in FIG. 7, the digital scene reconstruction system 106 generates a set of Gaussians 704 from a set of output token sequences 702. In particular, the digital scene reconstruction system 106 generates the set of Gaussians 704 based on the set of output token sequences 702 generated via a hybrid feed-forward neural network. In one or more embodiments, the digital scene reconstruction system 106 generates the set of Gaussians 704 as per-pixel predictions of the digital images represented by the set of output token sequences 702, for example, by linearly transforming and unpatchifying the set of output token sequences 702 (e.g., to reverse the previous process of patchifying and linearly transforming features of the sequence of input images).

In one or more embodiments, the digital scene reconstruction system 106 applies an opacity punishment to the set of Gaussians 704 generated from the set of output token sequences 702, lowering the opacity values of the set of Gaussians 704 where possible. More information on training the hybrid feed-forward neural network to apply the opacity punishment is described in relation to FIG. 8.

As further illustrated in FIG. 7, the digital scene reconstruction system 106 applies an opacity threshold 706 to the set of Gaussians 704 to generate a filtered set of Gaussians 708. In particular, the digital scene reconstruction system 106 utilizes the opacity threshold 706 to remove Gaussians from the set of Gaussians 704 that fall below the opacity threshold 706. In one or more embodiments, the digital scene reconstruction system 106 removes Gaussians from the set of Gaussians 704 with opacity values below 0.001, though in other embodiments, the opacity threshold 706 is a different opacity value. By filtering the Gaussians with opacity values below the opacity threshold 706, the digital scene reconstruction system 106 removes redundant Gaussians, which often make up a large percentage of the Gaussians (e.g., often as much as 60-70%).

As further illustrated in FIG. 7, the digital scene reconstruction system 106 generates a three-dimensional Gaussian reconstruction 710 from the filtered set of Gaussians 708. In particular, the digital scene reconstruction system 106 generates the three-dimensional Gaussian reconstruction 710 from the filtered set of Gaussians 708 to represent the three-dimensional scene depicted in input images (e.g., the set of digital images 302 of FIG. 3). In one or more embodiments, the digital scene reconstruction system 106 generates the three-dimensional Gaussian reconstruction 710 as a basis for generating one or more synthesized reconstructions from one or more novel views/perspectives. For instance, the digital scene reconstruction system 106 utilizes the three-dimensional Gaussian reconstruction 710 to generate novel views of the scene by rendering digital images of the scene using novel camera pose parameters in combination with the three-dimensional Gaussian reconstruction 710.

As mentioned, in one or more embodiments, the digital scene reconstruction system 106 trains a hybrid feed-forward neural network to predict Gaussian depth and punish Gaussian opacity. FIG. 8 illustrates a diagram of the digital scene reconstruction system 106 training a hybrid feed-forward neural network to predict three-dimensional reconstruction parameters in accordance with one or more embodiments.

As illustrated in FIG. 8, the digital scene reconstruction system 106 samples an input image 802. In one or more embodiments, the digital scene reconstruction system 106 accesses the input image 802 from a dataset stored locally (e.g., on the server device(s) 102 of FIG. 1) or remotely (e.g., on the database 112 or the client device 114 of FIG. 1). In one or more embodiments, the digital scene reconstruction system 106 accesses a set of input images in addition to the input image 802 (e.g., a long sequence of images representing various views of a three-dimensional scene).

As further illustrated in FIG. 8, the digital scene reconstruction system 106 utilizes a hybrid feed-forward neural network 804 to generate predicted three-dimensional reconstruction parameters 806. In particular, the digital scene reconstruction system 106 utilizes the hybrid feed-forward neural network 804 to generate the predicted three-dimensional reconstruction parameters 806 to predict the location and attributes of Gaussians in a three-dimensional Gaussian reconstruction based on the input image 802. In one or more embodiments, the digital scene reconstruction system 106 generates the predicted three-dimensional reconstruction parameters 806 to predict the positions, depths, opacities, and/or other attributes of the Gaussians.

As further illustrated in FIG. 8, the digital scene reconstruction system 106 generates a loss 810 by comparing the predicted three-dimensional reconstruction parameters 806 with ground-truth three-dimensional reconstruction parameters 808. In particular, the digital scene reconstruction system 106 generates the loss 810 to represent the difference between the predicted three-dimensional reconstruction parameters 806 with the ground-truth three-dimensional reconstruction parameters 808. In one or more embodiments, the digital scene reconstruction system 106 generates the loss 810 (e.g., a rendering loss) by utilizing a combination of mean squared error and perceptual loss. In one or more embodiments, the digital scene reconstruction system 106 generates the loss 810 according to the following equation:

$${L}_{image} = \frac{1}{M} {\sum }_{i = 1}^{M} ( MSE ( {I}_{i}^{gt} {I}_{i}^{pred} ) + λ \cdot Perceptual ( {I}_{i}^{gt} {I}_{i}^{pred} ) )$$

with L_{image} representing the total image loss, M representing the number of image samples, i representing the current image,

$${I}_{i}^{gt}$$

representing the ground-truth image,

$${I}_{i}^{pred}$$

representing the predicted image, MSE representing the mean squared error between the ground truth and predicted image, λ representing a weighting factor balancing the influence of the perceptual loss, and Perceptual representing perceptual loss.

In one or more embodiments, the digital scene reconstruction system 106 additionally generates the loss 810 to train the hybrid feed-forward neural network 804 to predict accurate Gaussian depth/positioning with a soft depth supervision. In one or more embodiments, the digital scene reconstruction system 106 generates the loss 810 with a depth constraint according to the following equation for scale-invariant depth loss L_{depth}:

$${L}_{depth} = \frac{1}{M} {\sum }_{i = 1}^{M} Smooth - L 1 ( {D}_{i}^{da} , {D}_{i}^{pred} )$$

with M representing the number of image samples, i representing the current image,

$${D}_{i}^{da}$$

representing a ground-truth disparity map, and

$${D}_{i}^{pred}$$

representing the predicted disparity map obtained from the predicted positions of the per-pixel Gaussians.

The digital scene reconstruction system 106 additionally normalizes the ground-truth disparity maps according to the following equation:

$$\frac{1}{HW} \sum \vert {d}_{i} - t ( {d}_{i} ) \vert$$

with HW representing the total number of pixels in the image, dᵢ representing the disparity maps, and t(dᵢ) representing the medians of the disparity maps.

In one or more additional embodiments, the digital scene reconstruction system 106 additionally generates the loss 810 to train the hybrid feed-forward neural network 804 to reduce the opacity of generated Gaussians by utilizing opacity regularization. In one or more embodiments, the digital scene reconstruction system 106 applies a regularization on the opacity of generated Gaussians according to the following equation:

$${L}_{opacity} = \frac{1}{N} {\sum }_{i = 1}^{N} \vert {o}_{i} \vert$$

with N representing the total number of Gaussians, |oᵢ| representing the absolute value of the opacity value of an element, and 1/N representing a normalization factor that averages the opacity values across all N Gaussians. The digital scene reconstruction system 106 utilizes the regularization to reduce the number of Gaussians with opacity values above 0.001, encouraging the sparsity of Gaussians in a three-dimensional Gaussian reconstruction.

The digital scene reconstruction system 106 combines the mean squared error and perceptual loss, the depth constraint, and the opacity regularization to generate the loss 810. In one or more embodiments, the digital scene reconstruction system 106 combines the mean squared error and perceptual loss, the depth constraint, and the opacity regularization according to the following equation:

$$L = {L}_{image} + {λ}_{opacity} \times {L}_{opacity} + {λ}_{depth} \times {L}_{depth}$$

with L_{image} representing the loss derived from the mean squared error and perceptual loss, λ_{opacity} representing a weighting factor for the opacity regularization, L_{opacity} representing a loss value for the opacity regularization, λ_{depth} representing a weighting factor for the depth constraint, and L_{depth} representing a loss value for the depth constraint. In one or more embodiments, the λ_{opacity} is set to 0.1 and the λ_{depth} is set to 0.01.

As further illustrated in FIG. 7, the digital scene reconstruction system 106 performs a parameter modification 812 to train the hybrid feed-forward neural network 804 (e.g., by modifying parameters of the hybrid feed-forward neural network 804) based on the loss 810. In particular, the digital scene reconstruction system 106 uses the parameter modification 812 to improve the ability of the hybrid feed-forward neural network 804 to generate the predicted three-dimensional reconstruction parameters 806 to match the ground-truth three-dimensional reconstruction parameters 808. In one or more embodiments, the digital scene reconstruction system 106 uses the parameter modification 812 to improve the ability of the hybrid feed-forward neural network 804 to predict accurate Gaussian depth/positioning while punishing opacity of Gaussians in the predicted three-dimensional reconstruction parameters 806.

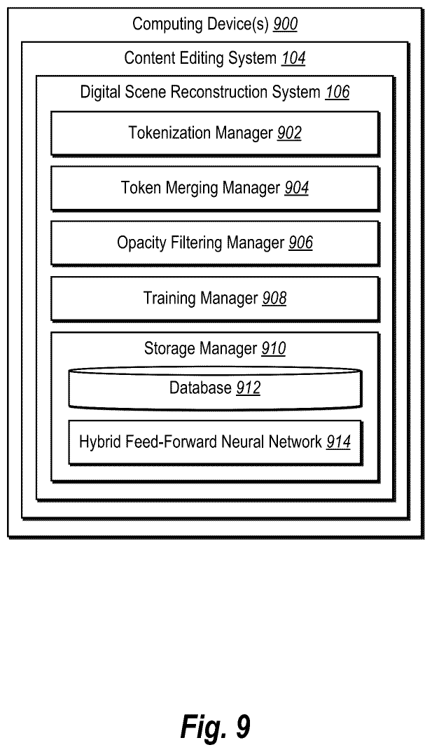

Referring now to FIG. 9, additional detail will be provided regarding components and capabilities of the digital scene reconstruction system 106. Specifically, FIG. 9 illustrates an example schematic diagram of the digital scene reconstruction system 106 on an example computing device(s) 900 (e.g., one or more of the client device 114 and/or the server device(s) 102). As shown in FIG. 9, the digital scene reconstruction system 106 includes a tokenization manager 902, a token merging manager 904, an opacity filtering manager 906, a training manager 908, and a storage manager 910.

As mentioned, the digital scene reconstruction system 106 includes a tokenization manager 902. In particular, the tokenization manager 902 generates, modifies, alters, or edits one or more token sequences (e.g., the initial set of token sequences 304 of FIG. 3) from a set of digital images (e.g., the set of digital images 302 of FIG. 3). For example, the tokenization manager 902 generates token sequences including image feature embeddings depicting color values and camera feature embeddings depicting camera pose parameters.

As mentioned, the digital scene reconstruction system 106 includes a token merging manager 904. In particular, the token merging manager 904 generates, modifies, alters, merges, or edits one or more token sequences (e.g., the initial set of token sequences 602 of FIG. 6) to generate a merged set of token sequences (e.g., the merged set of token sequences 608 of FIG. 6). For example, the token merging manager 904 applies a token merging layer to the one or more token sequences to generate a merged set of token sequences, reducing the size of the one or more token sequences.

As mentioned, the digital scene reconstruction system 106 includes an opacity filtering manager 906. In particular, the opacity filtering manager 906 modifies, alters, or removes one or more Gaussians from a set of Gaussians (e.g., the set of Gaussians 704 of FIG. 7) based on opacity values. For example, the opacity filtering manager 906 removes Gaussians from the set of Gaussians by applying an opacity threshold (e.g., the opacity threshold 706 of FIG. 7) to generate a filtered set of Gaussians (e.g., the filtered set of Gaussians 708 of FIG. 8).

As mentioned, the digital scene reconstruction system 106 includes a training manager 908. In particular, the training manager 908 trains a hybrid feed-forward neural network (e.g., the hybrid feed-forward neural network 914) to generate three-dimensional Gaussian reconstructions. For example, the training manager 908 accesses an input image and trains the hybrid feed-forward neural network to predict parameters of a three-dimensional Gaussian reconstruction. In additional embodiments, the training manager 908 trains the hybrid feed-forward neural network to predict the depth and punish opacity values of a three-dimensional Gaussian reconstruction.

The digital scene reconstruction system 106 further includes a storage manager 910. The storage manager 910 operates in conjunction with the other components of the digital scene reconstruction system 106 and includes one or more memory devices such as the database 912 (e.g., the database 112 of FIG. 1) that stores various data such as input images, three-dimensional Gaussian reconstructions, training data, and other information. In some cases, the storage manager 910 also manages or maintains a hybrid feed-forward neural network for generating three-dimensional Gaussian reconstructions using one or more components of the digital scene reconstruction system 106 as described above.

In one or more embodiments, each of the components of the digital scene reconstruction system 106 are in communication with one another using any suitable communication technologies. Additionally, the components of the digital scene reconstruction system 106 are in communication with one or more other devices including one or more client devices described above. It will be recognized that although the components of the digital scene reconstruction system 106 are shown to be separate in FIG. 9, any of the subcomponents may be combined into fewer components, such as into a single component, or divided into more components as may serve a particular implementation. Furthermore, although the components of FIG. 9 are described in connection with the digital scene reconstruction system 106, at least some of the components for performing operations in conjunction with the digital scene reconstruction system 106 described herein may be implemented on other devices within the environment.

The components of the digital scene reconstruction system 106 include software, hardware, or both. For example, the components of the digital scene reconstruction system 106 include one or more instructions stored on a computer-readable storage medium and executable by processors of one or more computing devices (e.g., the computing device(s) 900). When executed by the one or more processors, the computer-executable instructions of the digital scene reconstruction system 106 cause the computing device(s) 900 to perform the methods described herein. Alternatively, the components of the digital scene reconstruction system 106 comprise hardware, such as a special purpose processing device to perform a certain function or group of functions. Additionally, or alternatively, the components of the digital scene reconstruction system 106 include a combination of computer-executable instructions and hardware.

Furthermore, the components of the digital scene reconstruction system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the digital scene reconstruction system 106 may be implemented as part of a stand-alone application on a personal computing device or a mobile device. Alternatively, or additionally, the components of the digital scene reconstruction system 106 may be implemented in any application that allows creation and delivery of content to users, including, but not limited to, ADOBE® applications such as ADOBE® CAPTURE, ADOBE® PREMIERER, and ADOBE® AFTER EFFECTS®. “ADOBE,” “PREMIERE,” and “AFTER EFFECTS” are either registered trademarks or trademarks of Adobe Inc. in the United States and/or other countries.

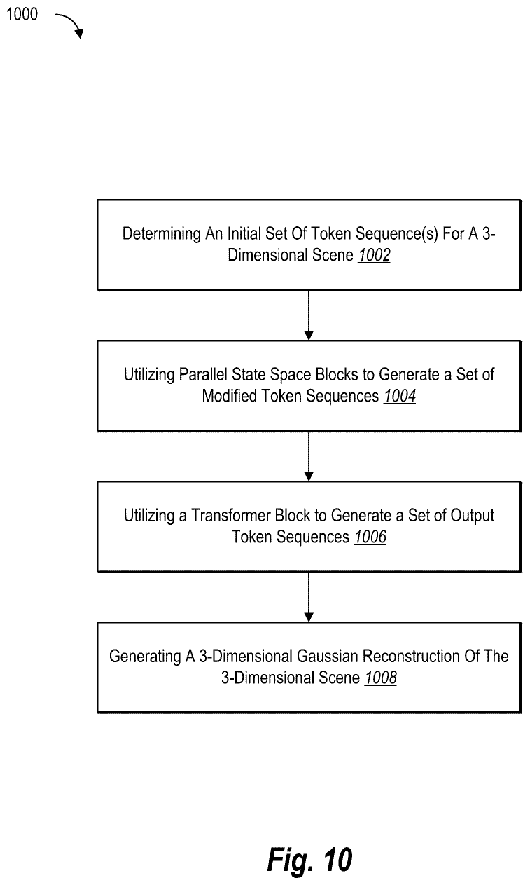

FIGS. 1-9, the corresponding text, and the examples provide a number of different systems, methods, and non-transitory computer readable media for generating a synthesized digital image from one or more reference digital images and a text prompt. In addition to the foregoing, embodiments can also be described in terms of flowcharts comprising acts for accomplishing a particular result. For example, FIG. 10 illustrates a flowchart of example sequences or series of acts in accordance with one or more embodiments.

While FIG. 10 illustrates acts according to particular embodiments, alternative embodiments may omit, add to, reorder, and/or modify any of the acts shown in FIG. 10. The acts of FIG. 10 can be performed as part of a method. Alternatively, a non-transitory computer readable medium can comprise instructions that, when executed by one or more processors, cause a computing device to perform the acts of FIG. 10. In still further embodiments, a system can perform the acts of FIG. 10. Additionally, the acts described herein may be repeated or performed in parallel with different instances of the same or other similar acts.

FIG. 10 illustrates an example series of acts 1000 for generating a three-dimensional Gaussian reconstruction of a three-dimensional scene. In particular, the series of acts 1000 includes an act 1002 of determining an initial set of token sequence(s) for a three-dimensional scene. For example, the act 1002 involves determining an initial set of token sequences representing a set of digital images depicting a set of view of a three-dimensional scene according to corresponding camera pose parameters. Further, the series of acts 1000 includes an act 1004 of utilizing parallel state space blocks to generate a set of modified token sequences. In particular, the act 1004 involves utilizing a set of parallel state space blocks in a hybrid feed-forward neural network to generate a set of modified token sequences from the initial set of token sequences by mixing token information in the initial set of token sequences. Further, the series of acts 1000 includes an act 1006 of utilizing a transformer block to generate a set of output token sequences. For example, the act 1006 includes utilizing a transformer block in the hybrid feed-forward neural network to generate a set of output token sequences from the set of modified token sequences. Further, the series of acts 1000 includes an act 1008 of generating a three-dimensional Gaussian reconstruction of the three-dimensional scene. For example, the act 1008 includes generating a three-dimensional Gaussian reconstruction of the three-dimensional scene from the set of output token sequences, with the three-dimensional Gaussian reconstruction used to synthesize digital images depicting the three-dimensional scene with novel views.

In some embodiments, the series of acts 1000 includes extracting image feature embeddings from the set of digital images depicting color values of the set of digital images. The series of acts 1000 also includes extracting camera feature embeddings from the corresponding camera pose parameters. The series of acts 1000 also includes generating the initial set of token sequences by combining the image feature embeddings and the camera feature embeddings.

In some embodiments, the series of acts 1000 includes dividing the digital images into sets of digital image patches. The series of acts 1000 also includes generating the image feature embeddings by linearly transforming the sets of digital image patches. The series of acts 1000 also includes concatenating the image feature embeddings and the camera feature embeddings to form the initial set of token sequences.

In some embodiments, the series of acts 1000 includes merging the initial set of token sequences into a merged set of token sequences with a lower dimensionality than the initial set of token sequences. The series of acts 1000 also includes generating the set of modified token sequences from the merged set of token sequences utilizing the hybrid feed-forward neural network.

In some embodiments, the series of acts 1000 includes generating a downsampled set of token sequences by applying a strided convolution layer to the initial set of token sequences. The series of acts 1000 also includes reshaping the downsampled set of token sequences to generate the merged set of token sequences. The series of acts 1000 also includes processing the initial set of token sequences through the set of parallel state space blocks and the transformer block in the hybrid feed-forward neural network in a plurality of iterations. The series of acts 1000 also includes utilizing a state space block of the set of parallel state space blocks to process the initial set of token sequences bidirectionally.

In some embodiments, the series of acts 1000 includes generating a set of Gaussians representing the set of digital images from the set of output token sequences. The series of acts 1000 also includes generating, from the set of Gaussians, a synthesized digital image from the three-dimensional Gaussian reconstruction depicting the three-dimensional scene with a novel view. The series of acts 1000 also includes determining an opacity threshold for the set of Gaussians. The series of acts 1000 also includes removing a subset of Gaussians from the set of Gaussians with opacity values below the opacity threshold.

In some embodiments, the series of acts 1000 includes determining an initial set of token sequences representing a set of digital images depicting a set of views of a three-dimensional scene according to corresponding camera pose parameters. The series of acts 1000 also includes generating a transformed set of token sequences by merging one or more tokens from the initial set of token sequences. The series of acts 1000 also includes generating, utilizing a set of parallel state space blocks and a transformer block in a hybrid feed-forward neural network, a set of output token sequences from the transformed set of token sequences. The series of acts 1000 also includes generating, from the set of output token sequences, a three-dimensional Gaussian reconstruction of the three-dimensional scene for synthesizing digital images depicting the three-dimensional scene with novel views.

In some embodiments, the series of acts 1000 includes extracting image feature embeddings representing color values of the set of digital images. The series of acts 1000 also includes extracting camera feature embeddings from the corresponding camera pose parameters. The series of acts 1000 also includes generating the initial set of token sequences by combining the image feature embeddings and the camera feature embeddings into a plurality of token sequences based on relationships between the digital images and the corresponding camera pose parameters.

In some embodiments, the series of acts 1000 includes merging the initial set of token sequences by applying a channel-wise, stride-2 convolution layer to the initial set of token sequences. The series of acts 1000 also includes passing the transformed set of token sequences through the hybrid feed-forward neural network in a plurality of iterations. The series of acts 1000 also includes merging the initial set of token sequences prior to a second iteration of the plurality of iterations.

In some embodiments, the series of acts 1000 includes determining state parameters from a token sequence of the initial set of token sequences utilizing a first linear layer. The series of acts also includes generating, of a state space block of the set of parallel state space blocks, a modified token sequence by performing a bidirectional scan of a token sequence of the initial set of token sequences according to the state parameters. The series of acts 1000 also includes transforming a sum of results of the bidirectional scan utilizing a second linear layer.

In some embodiments, the series of acts 1000 includes generating a set of Gaussians representing the set of digital images from the set of output token sequences. The series of acts 1000 also includes removing a subset of Gaussians from the set of Gaussians in response to determining that the subset of Gaussians have opacity values below an opacity threshold. The series of acts 1000 also includes determining a Gaussian loss that penalizes opacity values of Gaussians generated via the hybrid feed-forward neural network. The series of acts 1000 also includes modifying parameters of the hybrid feed-forward neural network to reduce the opacity values of the Gaussians generated via the hybrid feed-forward neural network utilizing the Gaussian loss.

In some embodiments, the series of acts 1000 includes determining an initial set of token sequences representing a set of digital images depicting a set of views of a three-dimensional scene according to corresponding camera pose parameters. The series of acts 1000 also includes generating, utilizing a set of parallel state space blocks in a hybrid feed-forward neural network, a set of modified token sequences from the initial set of token sequences by mixing token information in the initial set of token sequences. The series of acts 1000 also includes generating, utilizing a transformer block in the hybrid feed-forward neural network, a set of output token sequences from the set of modified token sequences. The series of acts 1000 also includes generating, from the set of output token sequences, a three-dimensional Gaussian reconstruction of the three-dimensional scene for synthesizing digital images depicting the three-dimensional scene with novel views.

In some embodiments, the series of acts 1000 includes generating the set of modified token sequences further comprises merging the initial set of token sequences into a merged set of token sequences by applying a strided convolution layer to the initial set of token sequences. The series of acts 1000 also includes training the hybrid feed-forward neural network by utilizing a depth loss function and a regularization loss function to modify parameters of the hybrid feed-forward neural network to predict positions of Gaussians forming the three-dimensional Gaussian reconstruction of the three-dimensional scene while penalizing opacity values of the Gaussians.

In some embodiments, the series of acts 1000 includes generating Gaussians representing the set of digital images from the set of output token sequences. The series of acts 1000 also includes removing a subset of the Gaussians having opacity values below an opacity threshold. The series of acts 1000 also includes generating the three-dimensional Gaussian reconstruction of the three-dimensional scene from the subset of the Gaussians.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

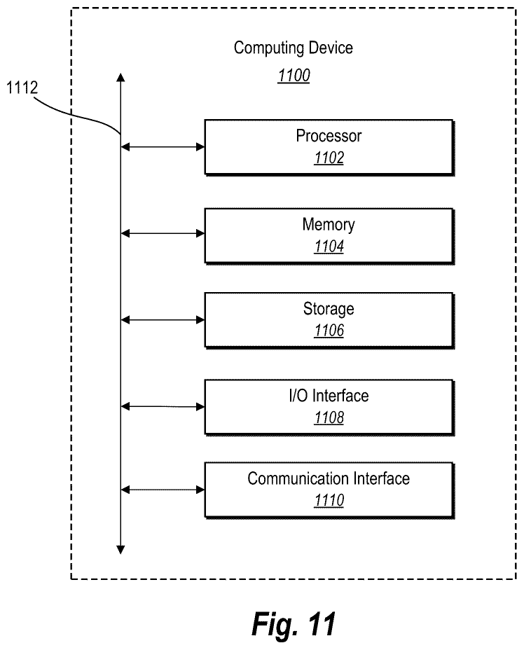

FIG. 11 illustrates, in block diagram form, an example computing device 1100 (e.g., the computing device(s) 900, the client device 114, and/or the server device(s) 102) that may be configured to perform one or more of the processes described above. As shown by FIG. 11, the computing device can comprise a processor(s) 1102, memory 1104, a storage device 1106, an I/O interface 1108, and a communication interface 1110.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them. The computing device 1100 includes memory 1104, which is coupled to the processor(s) 1102. The memory 1104 may be used for storing data, metadata, and programs for execution by the processor(s). The memory 1104 may include one or more of volatile and non-volatile memories. The memory 1104 may be internal or distributed memory. The computing device 1100 includes a storage device 1106 includes storage for storing data or instructions. As an example, and not by way of limitation, storage device 1106 can comprise a non-transitory storage medium described above. The computing device 1100 also includes one or more input or output (“I/O”) devices/interfaces 1108, which are provided to allow a user to provide input to (such as user strokes), receive output from, and otherwise transfer data to and from the computing device 1100. These I/O devices/interfaces 1108 may include a mouse, keypad or a keyboard, a touch screen, camera, optical scanner, network interface, modem, other known I/O devices or a combination of such I/O devices/interfaces 1108.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices (e.g., computing device 1100) or one or more networks. The computing device 1100 can further include a bus 1112. The bus 1112 can comprise hardware, software, or both that couples components of computing device 1100 to each other.

What is claimed is:

1. A computer-implemented method comprising:
determining an initial set of token sequences representing a set of digital images depicting a set of views of a three-dimensional scene according to corresponding camera pose parameters;
generating, utilizing a set of parallel state space blocks in a hybrid feed-forward neural network, a set of modified token sequences from the initial set of token sequences by mixing token information in the initial set of token sequences;
generating, utilizing a transformer block in the hybrid feed-forward neural network, a set of output token sequences from the set of modified token sequences; and
generating, from the set of output token sequences, a three-dimensional Gaussian reconstruction of the three-dimensional scene for synthesizing digital images depicting the three-dimensional scene with novel views.

2. The computer-implemented method of claim 1, wherein determining the initial set of token sequences comprises:
extracting image feature embeddings from the set of digital images depicting color values of the set of digital images;
extracting camera feature embeddings from the corresponding camera pose parameters; and
generating the initial set of token sequences by combining the image feature embeddings and the camera feature embeddings.

3. The computer-implemented method of claim 2, wherein determining the initial set of token sequences comprises:
dividing the digital images into sets of digital image patches;
generating the image feature embeddings by linearly transforming the sets of digital image patches; and
concatenating the image feature embeddings and the camera feature embeddings to form the initial set of token sequences.

4. The computer-implemented method of claim 1, wherein generating the set of modified token sequences further comprises:
merging the initial set of token sequences into a merged set of token sequences with a lower dimensionality than the initial set of token sequences; and
generating the set of modified token sequences from the merged set of token sequences utilizing the hybrid feed-forward neural network.

5. The computer-implemented method of claim 4, wherein merging the initial set of token sequences:
generating a downsampled set of token sequences by applying a strided convolution layer to the initial set of token sequences; and
reshaping the downsampled set of token sequences to generate the merged set of token sequences.

6. The computer-implemented method of claim 1, wherein generating the set of modified token sequences comprises processing the initial set of token sequences through the set of parallel state space blocks and the transformer block in the hybrid feed-forward neural network in a plurality of iterations.

7. The computer-implemented method of claim 1, wherein generating the set of modified token sequences further comprises utilizing a state space block of the set of parallel state space blocks to process the initial set of token sequences bidirectionally.

8. The computer-implemented method of claim 1, wherein generating the three-dimensional Gaussian reconstruction of the three-dimensional scene comprises:
generating a set of Gaussians representing the set of digital images from the set of output token sequences; and
generating, from the set of Gaussians, a synthesized digital image from the three-dimensional Gaussian reconstruction depicting the three-dimensional scene with a novel view.

9. The computer-implemented method of claim 8, wherein generating the set of Gaussians representing the set of digital images from the set of output token sequences further comprises:
determining an opacity threshold for the set of Gaussians; and
removing a subset of Gaussians from the set of Gaussians with opacity values below the opacity threshold.

10. A system comprising:
one or more memory devices; and
one or more processors coupled to the one or more memory devices that cause the system to perform operations comprising:
determining an initial set of token sequences representing a set of digital images depicting a set of views of a three-dimensional scene according to corresponding camera pose parameters;
generating a transformed set of token sequences by merging one or more tokens from the initial set of token sequences;
generating, utilizing a set of parallel state space blocks and a transformer block in a hybrid feed-forward neural network, a set of output token sequences from the transformed set of token sequences; and
generating, from the set of output token sequences, a three-dimensional Gaussian reconstruction of the three-dimensional scene for synthesizing digital images depicting the three-dimensional scene with novel views.

11. The system of claim 10, wherein determining the initial set of token sequences comprises:
extracting image feature embeddings representing color values of the set of digital images;
extracting camera feature embeddings from the corresponding camera pose parameters; and
generating the initial set of token sequences by combining the image feature embeddings and the camera feature embeddings into a plurality of token sequences based on relationships between the digital images and the corresponding camera pose parameters.

12. The system of claim 10, wherein generating the transformed set of token sequences comprises merging the initial set of token sequences by applying a channel-wise, stride-2 convolution layer to the initial set of token sequences.

13. The system of claim 12, wherein generating the set of output token sequences further comprises:
passing the transformed set of token sequences through the hybrid feed-forward neural network in a plurality of iterations; and
merging the initial set of token sequences prior to a second iteration of the plurality of iterations.

14. The system of claim 10, wherein generating the set of output token sequences comprises:
determining state parameters from a token sequence of the initial set of token sequences utilizing a first linear layer;
generating, of a state space block of the set of parallel state space blocks, a modified token sequence by performing a bidirectional scan of a token sequence of the initial set of token sequences according to the state parameters; and
transforming a sum of results of the bidirectional scan utilizing a second linear layer.

15. The system of claim 10, wherein generating the three-dimensional Gaussian reconstruction comprises:
generating a set of Gaussians representing the set of digital images from the set of output token sequences; and
removing a subset of Gaussians from the set of Gaussians in response to determining that the subset of Gaussians have opacity values below an opacity threshold.

16. The system of claim 10, wherein the operations further comprise:
determining a Gaussian loss that penalizes opacity values of Gaussians generated via the hybrid feed-forward neural network; and
modifying parameters of the hybrid feed-forward neural network to reduce the opacity values of the Gaussians generated via the hybrid feed-forward neural network utilizing the Gaussian loss.

17. A non-transitory computer-readable medium storing instructions thereon that, when executed by at least one processor, cause the at least one processor to perform operations comprising:
determining an initial set of token sequences representing a set of digital images depicting a set of views of a three-dimensional scene according to corresponding camera pose parameters;
generating, utilizing a set of parallel state space blocks in a hybrid feed-forward neural network, a set of modified token sequences from the initial set of token sequences by mixing token information in the initial set of token sequences;
generating, utilizing a transformer block in the hybrid feed-forward neural network, a set of output token sequences from the set of modified token sequences; and
generating, from the set of output token sequences, a three-dimensional Gaussian reconstruction of the three-dimensional scene for synthesizing digital images depicting the three-dimensional scene with novel views.

18. The non-transitory computer-readable medium of claim 17, wherein generating the set of modified token sequences further comprises merging the initial set of token sequences into a merged set of token sequences by applying a strided convolution layer to the initial set of token sequences.

19. The non-transitory computer-readable medium of claim 17, further comprising training the hybrid feed-forward neural network by utilizing a depth loss function and a regularization loss function to modify parameters of the hybrid feed-forward neural network to predict positions of Gaussians forming the three-dimensional Gaussian reconstruction of the three-dimensional scene while penalizing opacity values of the Gaussians.

20. The non-transitory computer-readable medium of claim 17, further comprising:
generating Gaussians representing the set of digital images from the set of output token sequences;
removing a subset of the Gaussians having opacity values below an opacity threshold; and
generating the three-dimensional Gaussian reconstruction of the three-dimensional scene from the subset of the Gaussians.
